(19) United States
(12) Patent Application Publication
(10) Pub. No.: US 2010/0164931 A1
(43) Pub. Date: Jul. 1, 2010

(54) PIXEL CIRCUIT AND METHOD FOR DRIVING A PIXEL

(75) Inventors: Chen Wei Lin, Kaohsiung City (TW); Yen-Shih Huang, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/616,437

(22) Filed: Nov. 11, 2009

(30) Foreign Application Priority Data
Dec. 31, 2008 (TW) 97151739

(51) Int. Cl. G09G 5/00

(52) U.S. Cl. 345/211

(57) ABSTRACT

A pixel circuit adaptable for a pixel array including a first scan line and a second scan line is provided. An illumination unit is coupled to a first node, including a light emitting diode that illuminates based on a voltage level of the first node. A first circuit is coupled to the first node, the first scan line and a data signal. A second circuit including one or more transistors, is coupled to the first node, the second scan line and a reference voltage. The second scan line has a scan order before that of the first scan line by one or more lines. When the first scan line is activated, the first circuit passes the data signal to the first node. When the second scan line is activated, the second circuit passes the reference voltage to the first node.

### CROSS REFERENCE TO RELATED APPLICATIONS

This Application claims priority of Taiwan Patent Application No. 97151739, filed on Dec. 31, 2008, the entirety of which is incorporated by reference herein.

### BACKGROUND

1. Technical Field

The disclosure is related to a display apparatus, and in particular, to a pixel circuit with a driving transistor that alleviates a threshold voltage drifting problem.

2. Description of the Related Art

Light emitting diode (LED) display panels are typically pixel array display panels comprising a plurality of pixels. Conventionally, each pixel circuit has an LED controlled by a driving transistor and a capacitor. When a scan line is activated, the pixel circuit receives a data signal, and the LED is driven to illuminate accordingly. Specifically, the gate to source voltage (V_{GS}) of the driving transistor determines whether a current should flow through the LED for illumination.

However, the threshold voltage of the driving transistor may gradually increase over a long period of usage of the pixel circuit. The phenomenon is referred to as a threshold drifting problem, which is irreversible because electronic components unavoidably fade as bias voltage is applied. The threshold voltage drifting problem may cause a data signal to render a lower than expected output current, thus consequently reducing luminance of the LED. Therefore, it is desirable to alleviate the threshold drifting problem and to compensate for the reduced driving current for LEDs.

### SUMMARY

An embodiment of a pixel circuit is provided, adaptable for a pixel array comprising a first scan line and a second scan line. An illumination unit is coupled to a first node, comprising a light emitting diode that illuminates based on a voltage level of the first node. A first circuit is coupled to the first node, the first scan line and a data signal. A second circuit comprising one or more transistors is coupled to the first node, the second scan line and a reference voltage. The second scan line has a scan order before that of the first scan line by one or more lines.

In another embodiment, a pixel driving method implemented for a pixel array is described. Firstly, a light emitting diode is provided to illuminate based on a voltage level of a first node. When the first scan line is activated, a data signal is transmitted to the first node. When a second scan line is activated, a reference voltage is transmitted to the first node. The second scan line has a scan order before that of the first scan by one or more lines.

A further embodiment of a pixel driving method is also provided. Firstly, a first scan line and a second scan line are sequentially scanned. When the first scan line is activated, a data signal is transmitted to a first pixel, and a reference voltage is transmitted to a second pixel, such that the first pixel is illuminated and the second pixel is turned off. When the second scan line is activated, a second data signal is transmitted to the second pixel, such that the second pixel is illuminated. A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1a shows an embodiment of a pixel circuit according to the disclosure;

FIG. 1b shows another embodiment of a pixel circuit according to the disclosure;

FIG. 2 is a timing diagram of scan lines according to the disclosure;

FIG. 3 is a flowchart of the pixel driving method according to the disclosure;

FIG. 4 shows an embodiment of a substrate according to the disclosure; and

FIG. 5 shows a relationship between the threshold voltage variation and the accumulated time of applying the bias voltage.

### DETAILED DESCRIPTION

The following description is an example of carrying out the disclosure. This description is made for the purpose of illustrating the general principles of the disclosure and should not be taken in a limiting sense. The scope of the disclosure is best determined by reference to the appended claims.

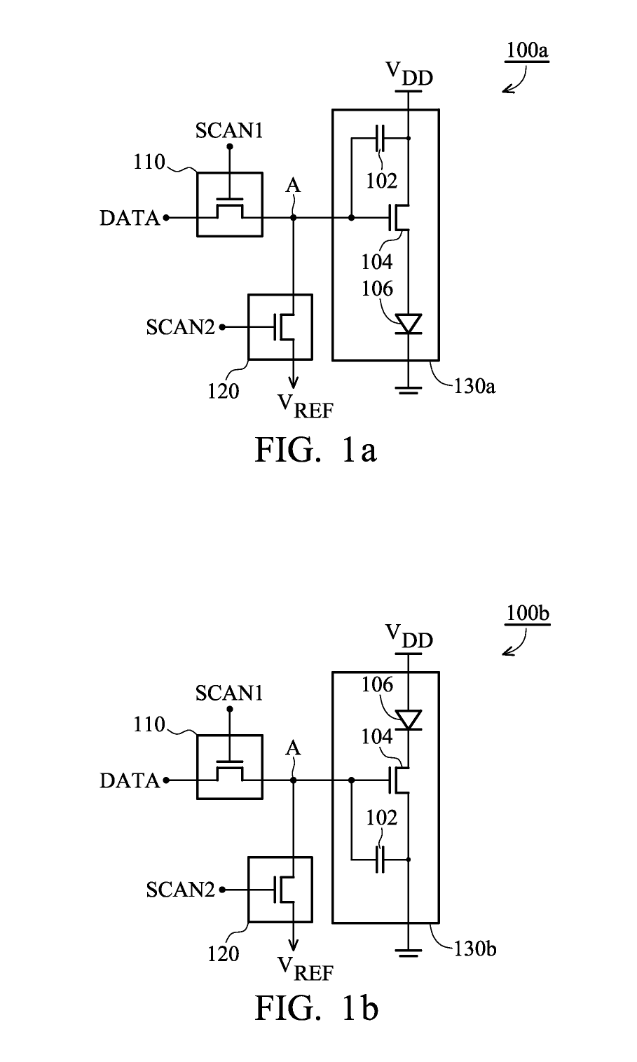

FIG. 1a shows an embodiment of a pixel circuit according to the disclosure. The pixel circuit 100a is composed of a first circuit 110, a second circuit 120 and an illumination unit 130a. The illumination unit 130a is coupled to the supply voltage V_{DD} and a voltage ground, illuminating based on the voltage level on node A. The voltage level on node A is controlled by the first circuit 110 and the second circuit 120 depending on various signal sources, which is described hereafter. Generally, a display panel comprises a plurality of scan lines, periodically and sequentially activated by a timing controller (not shown). When a scan line is activated, a corresponding row of pixel circuits are enabled to receive data signals DATA respectively for illumination. The first circuit 110 is controlled by a first scan line SCAN1 to provide a data signal DATA to the node A. The first circuit 110 comprises a transistor, having a gate coupled to the first scan line SCAN1, a drain coupled to the data signal DATA, and a source coupled to the node A. When the first scan line SCAN1 activates the first circuit 110, the voltage on node A is pulled up or down to approximate the data signal DATA. The illumination unit 130a comprises at least a capacitor 102, a driving transistor 104 and a light emitting diode (LED) 106. The driving transistor 104 has a drain connected to the supply voltage V_{DD}, and a gate connected to the node A. The capacitor 102 connects the drain and gate of the driving transistor 104, and the LED 106 connects the source of the driving transistor 104 to a voltage ground. Thus, the capacitor 102 stores a voltage difference between the node A and the supply voltage V_{DD}, causing the driving transistor 104 to generate a current to flow through the LED 106 to emit luminance accordingly. Because threshold voltage drift is exponentially proportional to the duration of bias voltage application to the gate and source of the driving transistor 104, the extent of drifting can be significantly reduced if the duration of bias voltage application is carefully controlled. In the embodiment, the illumination unit 130a is not only driven by the first circuit 110 to illuminate, but is also driven by a second circuit 120 to discharge. The second circuit 120 is dedicated to reduce the voltage level on node A, and activated for a brief duration that is unrecognizable to the human vision, so that bias voltage applied on the node A may be reduced. Note that the luminance on the pixel may be switched to dark during the brief duration, however, it would be unrecognizable to the human vision. In the embodiment, the second circuit 120 is activated when the second scan line SCAN2 is scanned. The second scan line SCAN2 may be before that of the first scan line SCAN1 by one line or by multiple lines. In other words, the second scan line SCAN2 has a scan order before that of the first scan line SCAN1, by one line or multiple lines. When one or more prior pixel circuits in the pixel circuit 100a are activated by the second scan line SCAN2 to charge their capacitors, the second circuit 120 is activated by the second scan line SCAN2 to pull down the voltage level of node A.

The second circuit 120 may be formed by a transistor, having a gate connected to the second scan line SCAN2, a source connected to a reference voltage V_{REF}, and a drain connected to the node A. The reference voltage V_{REF} may be an adjustable negative voltage or a voltage ground. For example, the reference voltage V_{REF} is designated to be a negative direct current voltage, whereby the voltage level on node A is pulled down when the second scan line SCAN2 activates the second circuit 120.

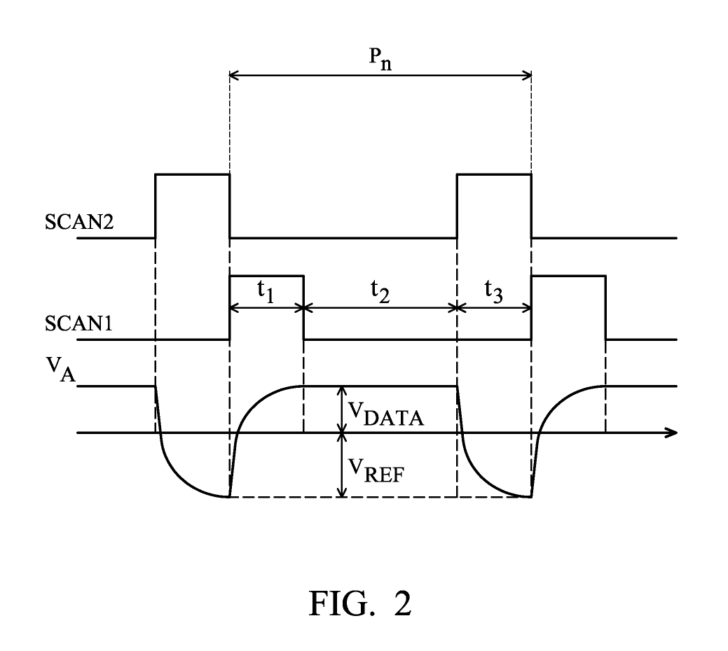

FIG. 1b shows another embodiment of a pixel circuit according to the disclosure. In comparison to the embodiment of pixel circuit 100a, the illumination unit 130b in the pixel circuit 100b is modified. In the illumination unit 130b, the gate of the driving transistor 104 is connected to the node A, the drain is connected to the negative end of the LED 106, and the source is grounded. The capacitor 102 is connected between the node A and the source of the driving transistor 104. The positive end of the LED 106 is connected to the supply voltage V_{DD}. When the first scan line SCAN1 activates the first circuit 110, the voltage of node A is pulled up to approximate the data signal DATA, such that the capacitor 102 is charged, and the driving transistor 104 generates a corresponding current to affect luminance of the LED 106. In order to prevent the driving transistor 104 from fading due to the bias voltage, when the second scan line SCAN2 is activated, the second circuit 120 pulls the voltage of node A down to approximately the reference voltage V_{REF}. A detailed timing diagram is shown in FIG. 2.

FIG. 2 is a timing diagram of the scan lines according to the embodiments of FIGS. 1a and 1b. The scan lines are periodically and sequentially activated. The second scan line SCAN2 and the first scan line SCAN1 are respectively activated at an interval Pn. In the embodiment, the first scan line SCAN1 is next to the second scan line SCAN2, thus the activation timing of the first scan line SCAN1 tightly follows that of the second scan line SCAN2. If the display panel has a refresh rate of 60 Hz, the interval Pn is actually 1/60 second. The interval Pn can be categorized into three stages. In stage t1, the first scan line SCAN1 is asserted, such that the first circuit 110 charges the capacitor 102 through node A, pulling the voltage V_{A} of node A up to approximately the voltage level of the data signal DATA, V_{DATA}. The stage t2 follows t1, during which time the first scan line SCAN1 is turned off, such that the capacitor 102 in the illumination unit 130a or illumination unit 130b is sustained at the voltage level V_{DATA} to drive the LED 106 to illuminate. Thereafter, the stage t3 follows the stage t2, during which time the scan order proceeds to activate the second scan line SCAN2. Thus, the second scan line SCAN2 is activated, allowing its corresponding pixel circuit to be charged by the data signal DATA. Simultaneously, the pixel circuit that was charged by the first scan line SCAN1, is discharged by the second scan line SCAN2. As shown in the stage t3, the voltage level V_{A} on the node A is pulled down to approximately the reference voltage V_{REF} by the second circuit 120. When the stage t3 ends, another period Pn starts over, and the processes described in the stages t1, t2 and t3 are repeated. Basically, the first scan line SCAN1 and second scan line SCAN2 have the same activation duration, wherein the duration of stages t1 and t3 are identical.

In other words, every scan line in the disclosure has two functions. One function is to charge a corresponding row of pixel circuits by their data signal DATA, and another function is to discharge a next row or rows of pixel circuits by a reference voltage V_{REF}. In a typical display panel, the scan lines are sequentially activated and the data signal DATA are updated row by row. When the last scan line is activated, the process starts over from the first scan line. That is to say, the last scan line is operative to charge the last row of pixel circuits to the data signal DATA, and simultaneously discharge the first row of pixel circuits to the reference voltage V_{REF}. The distance between the last scan line and the first row of pixel circuits, however, may be too long to be connected. To provide a discharge operation for the first row, an additional virtual scan line may be added to the pixel array, which would be deposited ahead of the first scan line. The virtual line does not charge any pixel, but merely performs the discharge operation as discussed in FIG. 2 to regulate operations for the first row of pixel circuits. Some display panels may not follow a sequential order to activate the scan lines, however, the pixel driving method of the disclosure can be adaptable in any scan order.

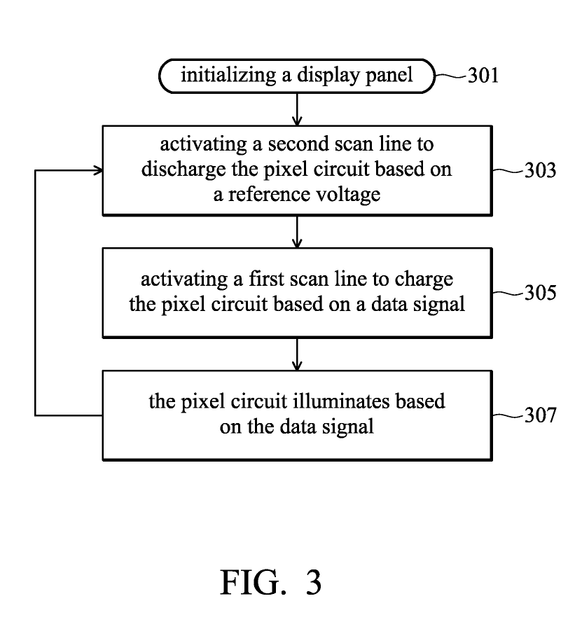

FIG. 3 is a flowchart of the pixel driving method according to the disclosure. The aforementioned descriptions can be summarized into the following steps. In step 301, a display panel comprising the pixel circuits as shown in FIGS. 1a and 1b is initialized, whereby the scan lines are sequentially scanned. In step 303, the second scan line SCAN2 is activated, pulling the voltage on node A down to approximate the reference voltage V_{REF}. Meanwhile, the gate to source voltage V_{GS} of the driving transistor 104 is pulled down to a negative value, which effectively prevents the driving transistor 104 from fading. In step 305, the second scan line SCAN2 is turned off while the first scan line SCAN1 is turned on, such that the data signal DATA is transmitted to the node A to charge the capacitor 102. In step 307, the LED 106 is driven by the capacitor 102 to emit luminance corresponding to the data signal DATA. Step 307 is followed by step 303, whereby the process is recursively repeated.

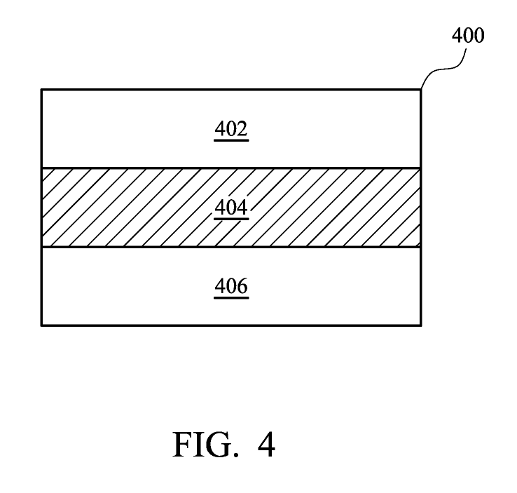

FIG. 4 shows an embodiment of a substrate according to the disclosure. The pixel circuit 100a of FIGS. 1a and 1b are basically implemented on a substrate. The substrate is a three layered structure comprising a top layer 402, a middle layer 404 and a bottom layer 406.

The pixel circuit 100a of FIG. 1a, for example, is printed on the substrate by a forward evaporation process. The bottom layer 406 comprises a circuit to supply the supply voltage V_{DD}, and other circuits such as the first circuit 110, the second circuit 120, the driving transistor 104 and the capacitor 102. After the bottom layer 406 is fabricated, the middle layer 404 is fabricated and the LED 106 is evaporation deposited thereon. After the middle layer 404 is fabricated, the top layer 402 is fabricated thereon and a voltage ground is eventually evaporation deposited on the top layer 402.

As another example, the pixel circuit 100b in FIG. 1b is adaptable to a reverse evaporation process. The voltage ground, the first circuit 110, second circuit 120, driving transistor 104 and the capacitor 102 are firstly evaporation deposited on the bottom layer 406. A middle layer 404 is then fabricated on the bottom layer 406, and an LED 106 is then evaporated on the middle layer 404. Thereafter, the top layer 402 is fabricated on the middle layer 404, and a supply voltage V_{DD} is deposited on the top layer 402. The structure of the pixel circuit may be designed based on various requirements and applications, which is not limited by the disclosure. A primary object of the disclosure is to use a previous scan line to prevent a driving transistor in a pixel circuit from fading over a long period of usage. The transistors in the first circuit 110 and second circuit 120 can be flexibly PMOS transistors or NMOS transistors depending on requirements of designers, and is not limited by the disclosure.

For some display panels, the scan order of the scan lines may not be sequential. For example, the scan order may be reversed by scanning from bottom to top, or interlaced by a particular rule. Thus, the term “previous” and “next” when referring to scan lines refer mainly to timing relationships rather than geographical relationship. That is, a “next” scan line may not necessarily be a scan line aside/below a “previous” scan line.

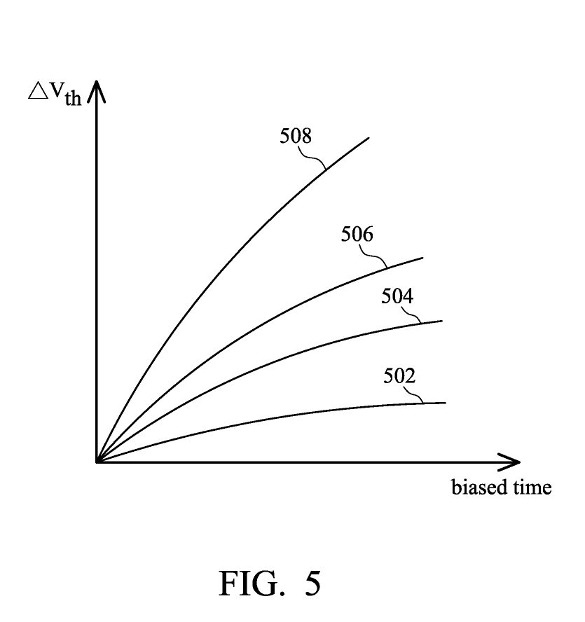

FIG. 5 shows a relationship between the threshold voltage variation and the accumulated time of applying the bias voltage. The curve 508 is a conventional threshold voltage variation trend, which shows that drifting extent increases as the bias voltage is applied for a longer period of time. Curves 502, 504 and 506 show different results when different reference voltages V_{REF} are applied to the pixel circuit. The curve 502 is a pixel circuit applied with a relatively low reference voltage V_{REF}, such as −8V. The curve 504 is a pixel circuit applied with a relatively high reference voltage V_{REF}, such as −4V, showing that the drifting is worse than the curve 502 while better than the conventional curve 508. The curve 506 is a pixel circuit applied with a reference voltage V_{REF} of 0V, showing that the drifting is still better than the conventional curve 508.

The reference voltage may be an adjustable negative voltage or a voltage ground. Generally, to avoid data signal DATA leakage through the second circuit, the reference voltage must be higher than the scan line switching off voltage minus the transistor threshold voltage. In other words, the scan line switching off voltage must be lower than the reference voltage plus the transistor threshold voltage. Thus, the reference voltage may be designated to be a positive voltage but with a low value that is not high enough to turn on the driving transistor. Such a method will still prevent the driving transistor from fading.

The number of transistors within the second circuit is not limited to be one. Multiple transistors may further be implemented, wherein each is connected to different scan lines. Thus, the second circuit may be activated by not only one previous scan line, but multiple previous scan lines. The LEDs described in the embodiments may be Organic LED (OLEDs) or Polymer LEDs (PLEDs). Specifically, various types of LEDs are adaptable in the disclosure.

While the disclosure has been described by way of example and in terms of the embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pixel circuit, adaptable for a pixel array comprising a first scan line and a second scan line, comprising:
an illumination unit, coupled to a first node, comprising a light emitting diode, illuminating based on a voltage level of the first node;
a first circuit, coupled to the first node, the first scan line and a data signal; and
a second circuit, comprising one or more transistors coupled to the first node, the second scan line and a reference voltage, wherein
the second scan line has a scan order before that of the first scan line by one or more lines.

2. The pixel circuit as claimed in claim 1, wherein:
when the first scan line is activated, the first circuit passes the data signal to the first node; and
when the second scan line is activated, the second circuit passes the reference voltage to the first node.

3. The pixel circuit as claimed in claim 2, wherein the illumination unit further comprises:
a driving transistor, having a gate coupled to the first node, a drain coupled to a supply voltage, and a source coupled to a positive end of the light emitting diode; and
a capacitor, coupled to the first node and the drain of the driving transistor, wherein the light emitting diode has a negative end coupled to a voltage ground.

4. The pixel circuit as claimed in claim 3, printed on a substrate by a forward evaporation process, wherein:
the substrate comprises a lower layer, a middle layer and a top layer;
the lower layer comprises a circuit for providing the supply voltage, the first circuit, the second circuit, the driving transistor and the capacitor;
the middle layer comprises the light emitting diode; and
the top layer comprises the voltage ground.

5. The pixel circuit as claimed in claim 3, wherein the illumination unit further comprises:
a driving transistor, having a gate coupled to the first node, a source coupled to a voltage ground, and a drain coupled to a negative end of the light emitting diode; and
a capacitor, coupled to the first node and the source of the driving transistor, wherein the light emitting diode has a positive end coupled to a supply voltage.

6. The pixel circuit as claimed in claim 4, is printed on a substrate by a reverse evaporation process, wherein:
the substrate comprises a lower layer, a middle layer and a top layer;
the lower layer comprises the voltage ground, the first circuit, the second circuit, the driving transistor and the capacitor;
the middle layer comprises the light emitting diode; and
the top layer comprises a circuit for providing the supply voltage.

7. The pixel circuit as claimed in claim 1, wherein the first circuit comprises a transistor having a gate coupled to the first scan line, a drain coupled to the data signal, and a source coupled to the first node.

8. The pixel circuit as claimed in claim 1, wherein the second circuit comprises a transistor having a gate coupled to the second scan line, a source coupled to the reference voltage, and a drain coupled to the first node.

9. The pixel circuit as claimed in claim 1, wherein the reference voltage is an adjustable voltage or a voltage ground.

10. The pixel circuit as claimed in claim 1, wherein the light emitting diode is an organic light emitting diode (OLED) or a polymer light emitting diode (PLED).

11. A pixel driving method, adaptable for a pixel array comprising a first scan line and a second scan line, comprising:
providing a light emitting diode to illuminate based on a voltage level of a first node;
when the first scan line is activated, passing a data signal to the first node; and
when a second scan line is activated, passing a reference voltage to the first node, wherein the second scan line has a scan order before that of the first scan by one or more lines.

12. The pixel driving method as claimed in claim 11, wherein the reference voltage is an adjustable voltage or a ground voltage.

13. The pixel driving method as claimed in claim 11, wherein the light emitting diode is an organic light emitting diode (OLED) or a polymer light emitting diode (PLED).

14. A pixel driving method, adaptable for a pixel array comprising a plurality of scan lines, comprising:
sequentially scanning a first scan line and a second scan line;
when the first scan line is activated, passing a data signal to a first pixel, and passing a reference voltage to a second pixel, such that the first pixel is illuminated and the second pixel is turned off; and
when the second scan line is activated, passing a second data signal to the second pixel, such that the second pixel is illuminated.

15. The pixel driving method as claimed in claim 14, wherein the reference voltage is an adjustable voltage or a voltage ground.

16. The pixel driving method as claimed in claim 15, wherein the reference voltage is a negative direct current voltage.

17. The pixel driving method as claimed in claim 14, wherein the reference voltage is a positive voltage that is too low to turn on the driving transistor.

18. The pixel driving method as claimed in claim 14, wherein the light emitting diode is an organic light emitting diode (OLED) or a polymer light emitting diode (PLED).
